(19) United States
(12) Patent Application Publication
(10) Pub. No.: US 2010/0295939 A1
(43) Pub. Date: Nov. 25, 2010

(54) TABLE GAUGE

(75) Inventors: John E. Hooning, Chadds Ford, PA (US); Tony Tuan Vu, Lancaster, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: INNOVATIVE IMAGING, INC, KENNETT SQUARE, PA (US)

(21) Appl. No.: 12/864,436

(22) PCT Filed: Jan. 19, 2009
(86) PCT No.: PCT/US09/31398

§ 371 Date: Jul. 23, 2010

Related U.S. Application Data
(60) Provisional application No. 61/023,929, filed on Jan. 28, 2008.

(51) Int. Cl. H04N 7/18

(52) U.S. Cl. 348/131; 348/E07.085

(57) ABSTRACT

A high resolution imaging system and method for using it. More specifically, the present invention relates to an imaging system including an imaging apparatus, a processor and a various features to minimize reflected and ambient light producing consistent, high fidelity images to facilitate high resolution imaging. The system may be used for material inspection and may be particularly beneficial for enlarging an image of an object, determining the geometry or morphology of an object surface, or enabling precise measurement of a feature of an object.

### FIELD OF THE INVENTION

The present invention relates to the fields of inspection, imaging and image analysis. More specifically, the present invention relates to an optical imaging system for material inspection and methods for using it.

### BACKGROUND OF THE INVENTION

Imaging apparatus comprising cameras, light sources and data analysis instruments are used in a variety of industries and applications, for both off-line and inline inspections. Current imaging systems typically have a downward looking camera and lighting to view an object positioned on a surface below the image sensor. Such systems have degraded performance for a variety of reasons and suffer from problems such as magnification variance, variant optical distortion and poor, uneven illumination.

Additionally, current systems incorporate cameras, optics, and lighting configured for specific objects and object sizes which generally require careful and repeatable placement and restraint of the object. Objects must be carefully arranged or held in a specific orientation and at a specific distance from the image sensor in order to obtain a clear, repeatable image with optimal illumination for accurate processing. Otherwise magnification changes, distortion variances across the field-of-view, and variant illumination will reduce measurement accuracies. Furthermore, many standard imaging systems are only capable of accommodating objects, and sample sets, having specific overall dimensions, thus requiring great care in sample preparation and requiring recalibration of the system for each object should optical magnification change. Consequently, current imaging systems are typically difficult to use and may be limited in their capability to capture consistent multiple views of an object or image multiple objects each having different dimensions or characteristics.

Some systems, such as those described in U.S. Patent Publication no. 2005/0278126 A1 (Rosakis), U.S. Pat. No. 5,361,308 (Lee) and U.S. Pat. No. 4,947,666 (Hametner et al.), do not provide for any means of minimizing optical variances and distortion inherent with reflected light vision systems, nor do these devices enable the unconstrained orientation of an object to be imaged.

Therefore there exists a need for a high resolution imaging and/or measurement and inspection system capable of mitigating and optimizing the effects of reflected and/or ambient light that does not constrain the orientation of an object to be imaged.

There is also a need for imaging and/or inspection systems that are easy to use, and are flexible for use in a variety of different ways.

### SUMMARY OF THE INVENTION

The present invention relates to an imaging or inspection system that provides a high resolution image with minimal distortion that allows very accurate image reproduction and measurements of various aspects of an object imaged or inspected by the system. In one aspect, the invention comprises an imaging apparatus, a processor and housing. The imaging apparatus includes a camera, an object inspection site located substantially at the focus plane of the camera lens, a light source for lighting the object inspection site and means for controlling light.

In another aspect, the invention comprises an imaging apparatus having a resolution of about 0.1 mil to about 1 mil. The imaging apparatus comprises an object inspection site, a camera, a light source and means for controlling light.

In a third aspect, the invention comprises a method for using an imaging or inspection system comprising an imaging apparatus including an object inspection site, a camera, a light source, a processor and a means for controlling light. The method involves the steps of placing an object at the object inspection site, controlling light, imaging the object, transmitting the image to a processor and analyzing the image.

### BRIEF DESCRIPTION OF THE DRAWINGS

FIG. 1 is a partial cutaway view of one embodiment of an imaging system of the present invention employing two polarizers with the front portion of the shroud 3 and the front and side portions of housing 4 cut away.

FIG. 2 is a partial side cross-sectional view of another embodiment of an imaging system of the present invention including additional light sources.

FIG. 3 is a partial cutaway view of yet another embodiment of an imaging system of the present invention that does not employ polarizers with the front portion of the shroud 3 and the front and side portions of housing 4 cut away.

FIG. 4 is a perspective view of an alternative embodiment of the shroud 3 for use with the embodiments of FIGS. 1-3 to inspect a cross-sectional end of an elongate object such as a pipe.

FIG. 5 is a partial cutaway view of another embodiment of an imaging system of the present invention useful for leather inspection with the front portion of the shroud 3 and the front and side portions of housing 4 cut away.

### DETAILED DESCRIPTION OF THE PREFERRED EMBODIMENTS

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatus and methods within the scope of the present invention. Before explaining the disclosed embodiments of the present invention in detail, it is to be understood that the invention is not limited in its application to the details of any particular embodiment shown. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

Unless otherwise defined, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described.

The present invention relates to an imaging system and to methods for its use. The system may be used, for example, to optically inspect an object, provide an enlarged image of an object, enable precise measurement of a feature of an object and/or analyze the geometry or curvature of an object surface or profile. The imaging system of the present invention is able to correct for optical distortion from reflected light and produce high contrast images with very uniform lighting. Furthermore, the imaging system is easy to use and does not require any special arrangement or handling of an object to be imaged.

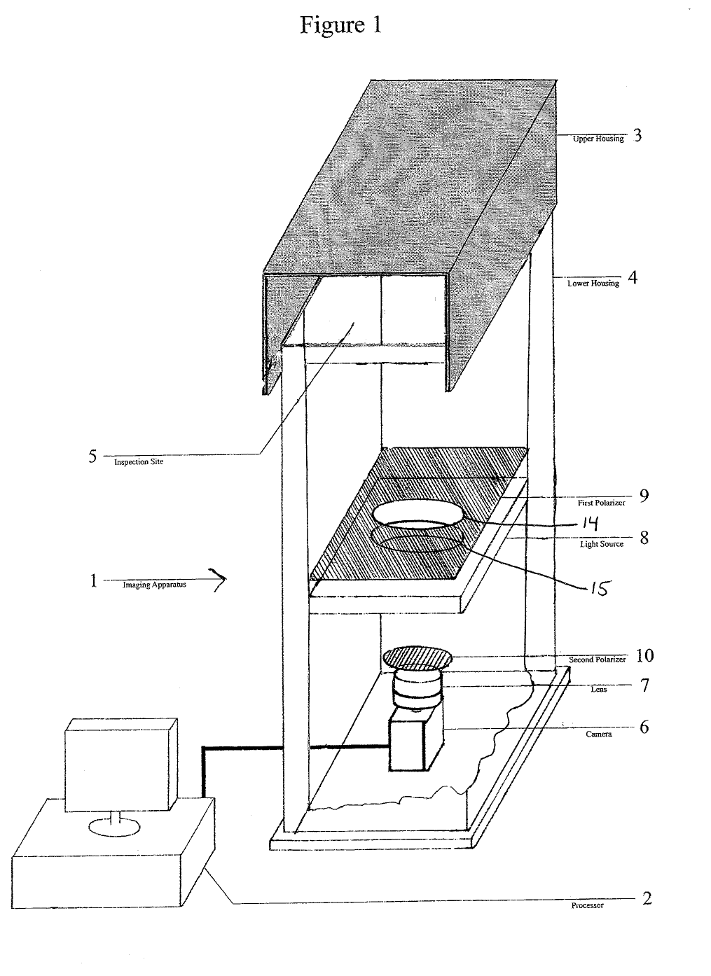

As shown in FIG. 1, the imaging system of the present invention may include an imaging apparatus 1, a processor 2 and a housing 3, 4. Imaging apparatus 1 also includes an object inspection site 5 and a camera 6. In an exemplary embodiment, imaging apparatus 1 is a compact, lightweight and portable device capable of imaging a variety of objects of varying sizes and dimensions. Housing 3, 4 of imaging apparatus 1 may be configured to have any shape and may be constructed from any suitable material. Housing 3, 4 functions to provide a support structure to which various elements of imaging apparatus 1 may be mounted. Another function of housing 3, 4 is to control exposure of the interior of housing 3, 4 to ambient light. A further function of housing 3, 4 is to interact with the internal lighting of imaging apparatus 1 so as to control the internal lighting. In one embodiment, housing 3, 4 is used to control light which might otherwise be reflected, or absorbed, off of an interior surface of housing 3, 4 during use of imaging apparatus 1.

In an exemplary embodiment, to enhance the imaging capability of imaging apparatus 1, at least the interior surface of housing 4 is preferably fabricated from a substantially non-specular reflective material, and, more preferably, a completely diffuse reflective material. The interior surface of housing 4 is employed in the present invention to control a significant portion of the lighting that is employed to light the object to be imaged. This is accomplished by selecting an appropriate light reflective ability for the interior surface of housing 4 for a particular imaging task.

For example, in some embodiments, interior surface of housing 4 could be a white, reflective material to maximize light reflection from interior surface of housing 4. In other embodiments, interior surface of housing 4 can facilitate the provision of diffuse, even lighting to the object to be inspected. The ideal interior surface of housing 4 may depend on issues such as the need to minimize interference from object surface imperfections and to provide edge contrast, for example.

Shroud 3 may be used to cover an object to be imaged and object inspection site 5 in order to deflect or absorb ambient light that would otherwise illuminate object inspection site 5. Preferably, the edges of shroud 3 may extend over the sides of lower housing 4 completely covering object inspection site 5 and the object to be imaged. Shroud 3 blocks ambient light from reaching objection inspection site 5 and the object being imaged, which might otherwise degrade and reduce contrast of the resultant image. In an exemplary embodiment, an interior surface of shroud 3 may be fabricated from any substantially non-reflecting material, preferably a completely non-reflecting material. The use of a substantially or completely non-reflecting material for the interior surface of shroud 3 maximizes the contrast, particularly the edge contrast, of the object to be imaged with the background against which the object is imaged since the interior surface of shroud 3 forms the background against which the object is imaged. This provides a significant advantage of the present invention since the resolution and accuracy of image processing software is noticeably enhanced when the image initially provided to the software for processing is a high contrast image.

Suitable materials and/or coatings for housing 3, 4 are known to skilled persons. In the embodiment shown, housing 3, 4 is formed from a lower housing 4 and a shroud 3 which may be removed from, or adjusted relative to, lower housing 4 for placement of an object on the object inspection site 5. For imaging or inspection, shroud 3 may be located atop lower housing 4 to form a functional housing 3, 4 as described above.

Object inspection site 5 is located within housing 3, 4, preferably substantially at the location of a focus plane of camera 6. Object inspection site 5 may include any suitable object inspection site. In the embodiment of FIG. 1, object inspection site 5 is provided by a transparent surface on which an object may be placed for analysis. Preferably, this type of object inspection site 5 is constructed from a substantially non-reflective transparent material having a reflectivity of about 6% or less, more preferably a non-reflective transparent material, most preferably a non-reflective glass or plastic surface having a reflectivity of about 2% or less. The percent reflectivity may vary depending on the wavelength of light employed, e.g. some materials exhibit a higher reflectivity for infrared light as compared to visible light.

The transparent surface of object inspection site 5 may have any suitable dimension that accommodates the object being imaged. Typically, the transparent surface is larger than the object area which is illuminated by the light source. Optionally, object inspection site 5 may also include a contoured surface area for cradling an object to be imaged or retention structures for retaining an object during imaging, such as fasteners, belts or clamps if it is desired to fix the object in a particular position for imaging or inspection.

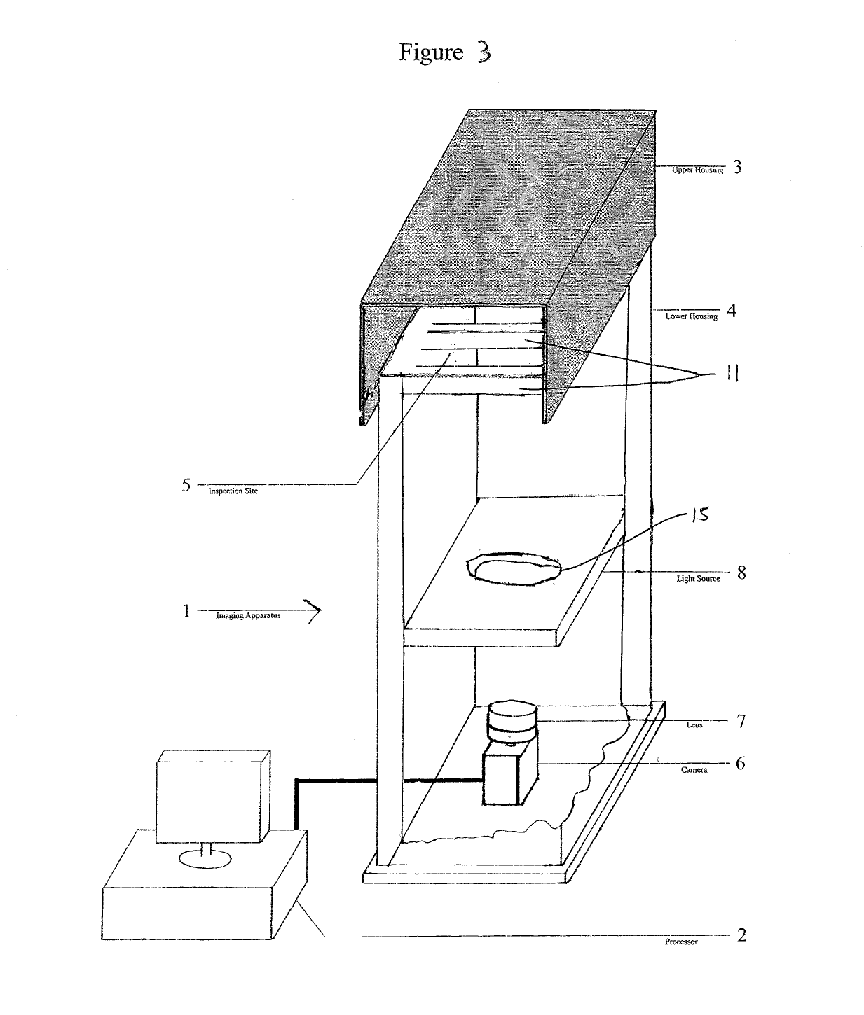

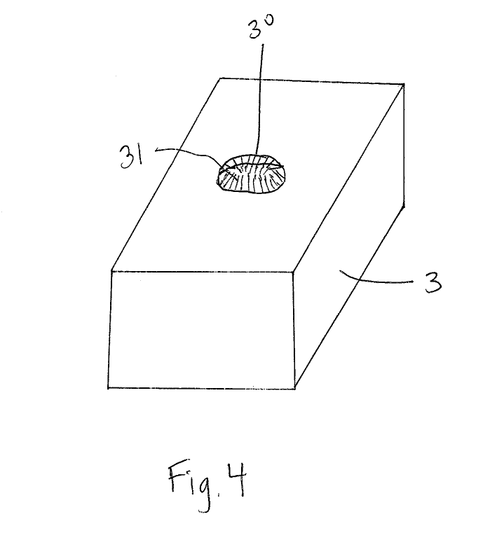

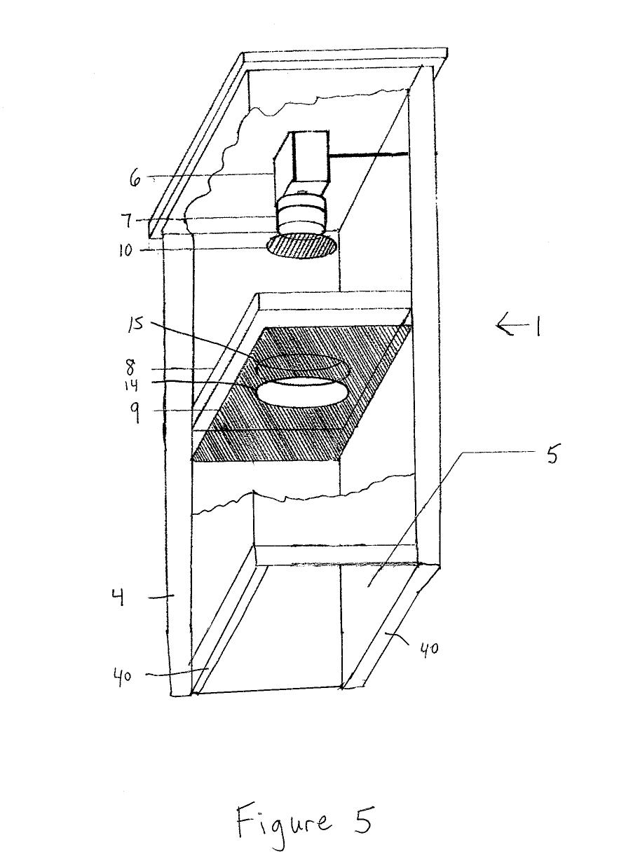

In other embodiments, such as that shown in FIG. 3, object inspection site 5 may be provided by apparatus for holding, positioning or supporting the object to be inspected. Thus, for example, in FIG. 3, object inspection site 5 is provided by two bars 11 which may be used to support an object at the focus plane of lens 7. Alternatively, in the embodiment of FIG. 4, object inspection site 5 is provided by apparatus 12 against which the object abuts when properly positioned at the focus plane of lens 7. In the embodiment of FIG. 5, object inspection site 5 is located at an end of imaging apparatus 1 and, as in FIG. 4, the device includes apparatus 13, in this case rollers 13, which abut against the object to be inspected to ensure proper positioning of the object at the focus plane of lens 7.

A camera 6 is located within housing 4 and is oriented and placed so as to be focused on object inspection site 5. Preferably, camera 6 is rotationally aligned with object inspection site 5 to minimize reflection and to image the entire surface area. Camera 6 includes a lens 7 that is preferably pre-focused and locked on object inspection site 5 to eliminate the need to focus lens 7 each time a new object is placed on object inspection site 5. Mirrors or other optical devices may also be used to adjust the distance from lens 7 to the focus plane, if desired. This step of orienting and focus lens 7 relative to object inspection site 5 pre-calibrates imaging apparatus 1 so that high resolution images may be obtained regardless of the orientation of an object on object inspection site 5. Any camera, including digital cameras, analog cameras, color cameras and black and white cameras, and line scan cameras may be used in imaging apparatus 1. For purposes of this invention, a camera is defined as any device capable of capturing an image including any video recording device, such as camcorders.

Preferably, camera 6 is capable of achieving a minimum pixel resolution of about 1600 by 1200. Measurement accuracy is determined by camera resolution and the area of inspection site 5. For area scan cameras/sensors pixel resolutions from 640×480 to 4992×6668 are currently available, and line scan cameras/sensors from 512 to 12,000. The size of the image inspection site 5 is significant since smaller areas allow greater resolution with the same camera since more pixels can be devoted per unit area if a smaller area is viewed.

In addition, since the device of the present invention is able to provide one or more of a high contrast image and consistent edge fidelity, this enables the use of software to implement sub-pixel interpolation techniques which allow even greater image resolutions by imaging at a sub-pixel level. Without being bound by theory, it is believed that resolutions of as small as 1/25^{th} of a pixel dimension may be possible using sub-pixel interpolation to process the image. Sub-pixel interpolation is a known method of image processing which interpolates information from the gray scale variant across an edge of the object image to provide sub-pixel accuracy for the image.

The device of the present invention provides consistent illumination and optical performance over the entire image inspection site thereby enabling use of sub-pixel interpolation with the object to be inspected located anywhere on the object inspection site 5. This makes the device easy to use since the operator merely needs to place the object at any location on object inspection site 5 without having to worry about locating the object at a very specific location to enhance the image.

As shown in FIG. 1, camera 6 includes at least one lens 7 and at least one light source 8. In the embodiment of FIG. 1, camera 6 and lens 7 are positioned to image the entire area of inspection site 5, although other arrangements for imaging only a portion of object inspection site 5 or imaging object inspection site 5 and some additional area, such as indicia indicating information about the object, may also be employed. Focus is adjusted, and locked, in order that the top surface of object inspection site 5 in FIG. 1 is the focus plane. In other embodiments, lens 7 is focused to ensure that the relevant portion of the object to be imaged is located in the focus plane when the object is located at object inspection site 5. For measurement applications a calibration target is placed on inspection site 5 and pixels per unit area, as well as optical distortion, are determined and recorded within processor 2. Additionally, the inspection surface may be covered with a white material and light evenness can be determined and recorded.

Imaging apparatus 1 of FIG. 1 preferably includes at least one polarizer which may be an adjustable polarizer. This polarizer is provided to reduce or eliminate light reflected from the lower surface of object inspection site 5 that might otherwise reach lens 7 of camera 6. In the method of the invention, one or more polarizers may be adjusted to reduce or eliminate light reflected from the lower surface of objection inspection site 5. Preferably, steps are taken to minimize reflection and thereby reduce or eliminate the need for polarizers since a significant amount, perhaps 60-90% of light, may be lost to the polarizers in order to eliminate reflection in the imaging apparatus.

In an exemplary embodiment, imaging apparatus 1 comprises a first polarizer 9 and a second polarizer 10 is located between lens 7 of camera 6 and object inspection site 5 to further minimize/remove reflection. In a preferred embodiment, each polarizer is a polymeric or glass material, more preferably, a polyimide or glass material. One adjustable polarizer may cover lens 7. One or both polarizers 9, 10 are oriented to minimize or eliminate reflection from the lower surface of object inspection area 5. Imaging apparatus 1 also includes at least one light source 8 capable of enabling imaging of an object placed at object inspection site 5. Light source 8 may be located anywhere within housing 4. In an exemplary embodiment, light source 8 surrounds lens 7, and the light is transmitted through a primary polarizer 10 to the transparent surface of the object inspection site 5. Any lighting, including visible, infrared, and ultraviolet lighting and dark field illumination, capable of providing a sufficient amount of light to the object inspection site 5 may be used. Preferably light source 8 produces highly diffuse light generated from LED and/or fluorescent bulbs. More preferably, light source 8 produces a diffuse light that is substantially uniform and minimizes localized reflections. Most preferably, the light source 8 is an LED array covered with a polymeric material, preferably frosted acrylic plexiglass that enhances the provision of uniform diffuse lighting.

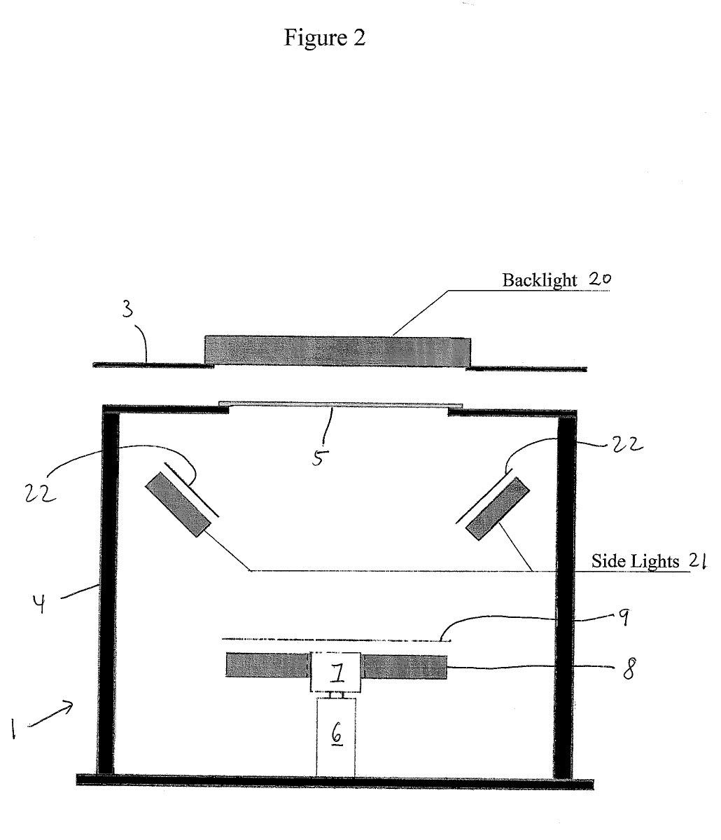

In alternative embodiments, one of which is depicted in FIG. 2, additional lighting other than light source 8 may be provided. Such additional lighting may include at least one back light 20 that may be used, for example, to create a silhouette of an object and/or at least one side light 21 that may be used, for example, to enable dark field illumination of an object. In some embodiments it may be advantageous to provide dark field illumination by using only side lighting of the object in addition to light source 8. Such a combination of lights can be used to ensure the provision of a high contrast image that lends itself to sophisticated software processing techniques and increased sub-pixel accuracy thereby enabling high resolution images allowing inspection of small details in the object. Embodiments employing side lights 21 may require one or more additional polarizers 22 to control reflection for the side lighting. In one embodiment of the invention, one or more ultraviolet light sources can be employed in combination with an ultraviolet camera, if desired. Alternatively, infrared light may be employed in certain embodiments.

In an exemplary embodiment, light source 8 has the same relative shape and size as inspection site 5 to enhance light intensity and evenness. Preferably, light source 8 may be customized to provide a uniform diffuse light over a desired portion of object inspection site 5, more preferably over the entire surface of object inspection site 5. Light source 8 may, in some embodiments, be located between lens 7 and object inspection site 5. In such a case, opening 15 is provided to allow light from object inspection site 5 to pass through light source 8 to lens 7, as shown in FIG. 1. First polarizer 9 also preferably includes a corresponding opening 14 therein. Second polarizer 10 may be aligned with opening 14 in first polarizer 9 to eliminate or reduce reflected light from a lower surface of object inspection site 5 that passes through opening 14 in first polarizer 9.

If light source 8 is located below or behind lens 7, relative to the position of object inspection site 5, again an opening 15 may be provided in light source 8 such that light source 8 surrounds lens 7 since back-lighting of lens 7 would be of no value. Location of light source 8 between lens 7 and object inspection site 5 is preferred since camera 6 and/or lens 7 may interfere with light transmission from light source 8 to object inspection site 5 if light source 8 is located below or behind camera 6, relative to object inspection site 5. Preferably, light source 8 is located a sufficient distance from object inspection site 5 to ensure that the diffuse light fills in the void created by opening 15 in light source 8. Camera 6 may also include a shading correction to compensate for non-ideal light sources and lighting non-uniformity, if necessary.

Means for controlling light may include any one or more of the following options: the provision of a specific type of lighting, the positioning of one or more light sources, the shape(s) of the one or more light sources, the provision of multiple light sources, the provision of one or more polarizers, the adjustment of one or more polarizers, the light absorbance/reflective properties of an interior surface or portion of housing 4 and/or shroud 3, and the use of housing 3, 4 to minimize or prevent ambient light from reaching the interior of the housing. Also, means for controlling light may include software compensation by processor 2, for example, by calibration of the device prior to use. In one embodiment, a white surface or object may be located at object inspection site 5 and image processing may be done to compensate for any unevenness in the light observed on the white surface or object. This is possible since the lighting provided for imaging is a fixed quantity because this lighting is provided by consistent devices located within housing 3, 4 and not influenced by ambient lighting from outside housing 3, 4.

Camera 6 is enabled for transmission of data to processor 2, by suitable cabling or wireless connection. Processor 2 of the imaging system may be used to analyze and/or manipulate an image captured by camera 6. As required, processor 2 may also be capable of correcting distortions created by wide-angle camera lenses, correcting uneven lighting, displaying varying degrees of magnification of an imaged object, detecting defects on an imaged object, and/or precisely measuring one or more features of an imaged object.

The imaging system of the present invention may produce high field depth images and high resolution images of and has the capability to measure features to accuracies of from about 0.1 mil to about 5 mil, more preferably, about 0.5 mil to about 2.5 mil and most preferably, about 0.5 mil to about 1 mil. The imaging system of the present invention significantly improves on prior imaging technologies by producing consistent high fidelity and high contrast images. This is accomplished through providing a diffuse, even illumination while minimizing the amount of reflected and ambient light which permits a very high image resolution and precise measurement of features of an object. Without wishing to be bound by theory, the housing, alignment of the camera with respect to the object inspection site, the optional use of one or more polarizers, the provision of uniform diffuse lighting and substantially non-reflective shroud substantially reduces the amount of reflected and ambient light that causes optical distortions and degradations. These measures enable high-resolution imaging and accurate measurement of imaged objects.

In another aspect of the invention, the imaging system may be used to image an object. First an appropriate camera 6, lens 7 and light source 8 may be selected for each imaging application. Camera 6 may then be oriented and positioned with respect to object inspection site 5 to focus on an object. The distance from lens 7 of camera 6 to the object is controlled by inspection site 5. The optional polarizers may then be adjusted to minimize the amount of reflected light from object inspection site 5. This calibration of camera 6 enables high resolution imaging regardless of the placement or orientation of an object located on object inspection site 5. An object may then be randomly placed or dropped anywhere on or at object inspection site 5 in any orientation. Optionally, the object may be secured to object inspection site 5 using a retaining mechanism. Shroud 2 is preferably placed over the object and object inspection site 5 so that the sides of shroud 2 extend completely over the object and object inspection site 5 to minimize exposure to ambient light. Camera 6 may then be used to capture an image of the object, which may be transmitted to processor 2. The images may be remotely transmitted and subsequently analyzed. Alternatively, the images may be transmitted after camera 6 is connected to processor 2 with a cable, USB cord, wirelessly or any suitable connection. Processor 2 may be used to correct an optical distortion, correct for uneven lighting, enlarge the transmitted images, measure a feature of the transmitted images, compare a transmitted image with another image, determine the geometry or curvature of an imaged object from the transmitted image, and/or measure and identify any defects of an imaged object from the transmitted image. Additionally, the enclosure and shroud design inhibit dirt and dust contamination of optical surfaces greatly reducing the need for cleaning, while also minimizing physical contact with camera 6 and lens 7 thus reducing the need for recalibration. Positive air pressure may be applied internally to housing 3, 4 to further reduce optical contamination.

It is envisioned that the imaging system of the present invention may be useful for a number of applications that require magnification of an optical image or the precise measurement of a feature of an object with an accuracy equivalent to the resolution and image fidelity of the resultant image. In particular, the imaging system may be especially beneficial for determining the geometry of the surface of an object, enabling microscopic and enlarged analysis of an object, facilitating quality control inspection in manufacturing, inspecting construction materials and extruded products such as PVC piping, soft products (i.e. fabrics, papers, leathers), measuring particles, detecting counterfeit objects and analyzing fingerprints or assisting individuals who are visually impaired. Additionally, the imaging system may be configured as a table gauge for making measurements, configured to assist individuals who are vision impaired, or provide a high magnification image for visual assessment of objects such as gem stones for example.

In an alternative embodiment of the present invention, continuous measurement can be undertaken by moving objects across the object inspection site. Thus, for example, a suitable conveying apparatus can be associated with the device of the present invention to move objects across the object inspection site for continuous inspection. Also, one or more encoders could be employed for accurate positioning of an object on said object inspection site. This would permit, for example, comparison of the object to a database of objects or object parts. In this manner, objects could be identified, and additional information about objects could be obtained from a database based on identification of the object or a component part thereof, or edges of an object could be inspected or imaged.

Referring to FIG. 3, there is shown an alternative embodiment of the invention. In this embodiment, object inspection site 5 is provided by a means such as a mechanical stop, a gripper, a vise, or bars 12, which position or hold the object at a particular location in the focus plane of lens 7 Should the mechanical fixtures which provide object inspection site 5 be within the field-of-view of camera 6, such fixtures will always be found at the same location and thus allow for processor 2 to discount, or correct for, the presence of these fixtures, as well as for information that may be obscured by these fixtures. One advantage of this embodiment is that this embodiment eliminates the problem of reflection off of the surface that provides the object inspection site 5 in the embodiment of FIG. 1. Another advantage of the use of a fixed means for providing object inspection site 5, such as a mechanical stop or bars, is that the means is always at a fixed location relative to the image sensor and thus the imaging system can be calibrated to account for the position of this means and the exact position of the object to be imaged. As a result, it is possible to eliminate one or both polarizers of the embodiment of FIG. 1, when implementing the alternative embodiment of FIG. 3.

Thus, the embodiment of FIG. 3 is characterized by the provision of the object lighting from within the housing 3, 4, the use of apparatus associated with housing 3, 4 to position the object at object inspection site 5 and means for controlling light inside housing 3, 4. Although polarizers are not necessary in the embodiment of FIG. 3 to reduce or eliminate light reflected from object inspection site 5, it may be desirable in some embodiments to reduce or eliminate light reflected from the imaged object, particularly for objects with shiny or reflective surfaces. In such case, one or more polarizers could be employed in the embodiment of FIG. 3 for this purpose.

Referring to FIG. 4, there is shown an alternative embodiment of shroud or upper housing 3 which may be used with any of the embodiments of FIGS. 1-3 or other embodiments of the present invention. This embodiment is particularly useful for inspection of an end of an elongate object such as a length of pipe. Specifically, shroud 3 includes an opening 30 therein which is sized to allow passage of the object to be inspected, in this case a cylindrical pipe, through opening 30. Thus, employing shroud 3 of FIG. 4 with the embodiment of FIG. 1, imaging apparatus 1 is positioned relative to a cylindrical length of pipe such that an end of the pipe to be inspected may be inserted through opening 30 in shroud 3. The end of the pipe is then inserted a sufficient distance to locate the end of the pipe against the transparent surface, or a mechanical stop that provides object inspection site 5 and inspection of the pipe may be carried out. The implementation of this embodiment is facilitated by the small, portable nature of the imaging apparatus 1.

In a more preferred embodiment of FIG. 4, opening 30 is provided with a means 31 for blocking some or all ambient light from passing through opening 30 in shroud 3 when a the object to be inspected is inserted through opening 30. In the embodiment shown in FIG. 4, opening 30 is provided with a means such as a flexible gasket or a plurality of bristles 31 which surround the object to be inspected and minimize transmission of ambient light through opening 30 into the interior of housing 3, 4. For implementation of the embodiment of FIG. 4 with the embodiment of FIG. 3, the end of the pipe is inserted until it abuts a stop means such as bars 12, at which point it will be positioned for imaging.

Referring to FIG. 5, there is shown another alternative embodiment of the invention which may be used for inspection of leather or surfaces which are larger than the area of inspection site 5. This embodiment is similar to the embodiment of FIG. 1, except that, in use, the imaging apparatus 1 will be oriented upside down, relative to the embodiment of FIG. 1, as shown in FIG. 5. In this embodiment, object inspection site 5 is placed against or adjacent to a surface of an object to be imaged and means such as rollers 40 or wheels may be employed to move imaging apparatus 1 relative to the object surface to image different portions of the object. The imaging apparatus 1 of FIG. 5 can be moved to different locations on a large surface and, by taking several images of the surface, can inspect the entire surface of, for example, a leather object, for defects. For leather inspection, near IR illumination is preferred to discount the effects of different color.

In one embodiment, a line scan camera could be used to create an image of the entire surface as the device is moved relative to the object. In this instance, an encoder attached to rollers 40 or wheels may be used to control the readout of the line scan camera. In this embodiment, the entire object inspection site 5 can be covered by the object to be inspected in order to prevent ambient light from reaching lens 7.

The embodiment of FIG. 5 may also be implemented using the device of FIG. 3, i.e. without polarizers or an object inspection surface. In this case, imaging could be done between rollers 40 or the wheels.

The device of the present invention may be employed for off-line measurement of objects, for example, to inspect parts or manufactured objects for quality control purposes or to identify defects. Alternatively, the device of the present invention may be used as part of a feedback control loop wherein measurements taken by the device are used to provide information used for feedback control of a device or process for manufacturing, machining or altering a part or object.

### EXAMPLES

### Example 1

### Inspection of Polyvinyl Chloride (PVC) Pipe

A device in accordance with FIG. 1 of the present application was assembled and tested for inspection of PVC pipe. Specifically, the goal was to accurately measure the thickness of coatings applied to a sample section of PVC pipe that had been cut by a saw blade from a larger section of manufactured PVC pipe. Many conventional inspection devices cannot perform this operation because the light reflections from ridges in the PVC pipe left behind by the saw blade cutting the pipe interfere with observation of the coatings on the pipe, making such observation difficult. The present invention, however, employs highly diffuse illumination in combination with polarizes to substantially eliminate light reflection from surface imperfections, such as the ridges left behind by the saw blade cutting the PVC pipe.

As a result, the device of the present invention was able to accurately measure the coating thicknesses of coatings applied to the PVC pipe to ensure that such coatings had been properly applied. Coating thickness measurement accuracies to within a few mils were easily achieved.

### Example 2

The device in accordance with FIG. 1 of the present application employed in Example 1 was also tested for inspection of leather samples for manufacturing defects in the leather. Again, this is a difficult exercise for many conventional inspection systems because the natural surface texture and surface patterns of the leather may be easily mistaken for defects in the leather using such conventional inspection systems.

The device of the present invention, by virtue of its use of highly diffuse illumination, substantially eliminates the effects of surface textures and patterns on the leather from the image. It was found that certain types of defects in the leather could also be exposed by use of dark field illumination. Thus, the present device was demonstrated to be useful for leather inspection.

The device should be similarly useful for inspection of soft, flexible materials such as fabrics since distortion of the image is minimized by the fact that the object can be laid flat on the object inspection site 5. Characters and barcodes weaved within the material can efficiently be decoded via processor 2 due to the image consistency, evenness of illumination, and mitigation of distortion.

Additionally, the invention will be useful for particle sizing since particulates may be oriented and illuminated in an optimal manner for this purpose. Particle stacking is mitigated to a significant degree by the action of gravity at object inspection site 5 while sample preparation for measurement is easy to implement since the particles can be randomly placed within inspection area 5.

It is to be understood that although numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. An imaging apparatus comprising:
a housing;
an object inspection site;
a camera including a lens focused and fixed on said object inspection site,
a light source; and
means for controlling light at said object inspection site and said lens, said means for controlling light including at least one polarizer located between said source and said object inspection site.

2. An imaging apparatus as claimed in claim 1, wherein said means for controlling light comprises one or more interior surfaces of said housing provided with a material or coating having a predetermined light reflectivity or absorbance.

3. (canceled)

4. An imaging apparatus as claimed in claim 1, wherein said means for controlling light comprises a second polarizer located between said lens and said object inspection site.

5. An imaging apparatus as claimed in claim 1, wherein said means for controlling light comprises one or more additional light sources.

6. An imaging apparatus as claimed in claim 5, wherein said means for controlling light comprises one or more polarizers located between said additional light sources and said object inspection site.

7. An imaging apparatus as claimed in claim 1, wherein said object inspection site comprises means for positioning said object at the camera focus plane.

8. An imaging apparatus as claimed in claim 1, further comprising means for moving said imaging apparatus over a surface of said object to be inspected.

9. The imaging system of claim 1, wherein said light source produces a substantially uniform and substantially diffuse light for said object inspection site.

10. The imaging system of claim 1, wherein said housing comprises a lower housing and a shroud which can be removed from, or adjusted relative to, said lower housing to permit access to said object inspection site.

11. The imaging system of claim 1, further comprising a processor operatively associated with said camera for processing information from said camera.

12. The imaging system of claim 11, wherein said processor outputs a measurement of a feature of an object located on said object inspection site.

13. The imaging system of claim 11, wherein said processor-outputs an image of an object located on said object inspection site

14. The imaging system of claim 1, wherein an interior surface of said housing comprises a substantially non-specular reflective material.

15. The imaging system of claim 1, wherein said imaging system has a resolution of from about 0.1 mil to about 5 mil.

16. The imaging system of claim 1, wherein said imaging system has a resolution of from about 0.5 mil to about 1 mil.

17. The imaging system of claim 1, wherein said light source comprises at least one back light that produces a silhouette of an object being imaged.

18. The imaging system of claim 1, wherein said light source comprises at least one side light to enable dark field imaging.

19. The imaging system of claim 1, wherein the system is employed for off-line measurement.

20. The imaging system of claim 1, wherein the system is employed as part of a feedback control loop.

21. A method for imaging comprising the steps of:
(a) providing an imaging apparatus comprising:
a housing;
an object inspection site;
a camera having a lens;
a light source;
means for controlling light in said housing including at least one polarizer located between said light source and said object inspection site; and
a processor operatively associated with said camera,
(b) placing an object on said object inspection site;
(c) covering said object and said object inspection site with a portion of said housing;
(d) polarizing light from said light source using said at least one polarizer:
(d) imaging said object with said camera using polarized light from said light source;
(e) transmitting information about said object from said camera to said processor; and
(f) analyzing said image with said processor to provide an output.

22. The method of claim 21, wherein said output is a measurement of a feature of an object.

23. The method of claim 21, further comprising the step of calibrating said imaging apparatus prior to step (b).

24. The method of claim 21, wherein the step of analyzing said image comprises performing an action selected from the group consisting of: correcting an optical distortion of said image, enlarging said image, measuring a feature of said object based on said image, comparing said image with another image, determining a geometry of said object based on said image, and identifying a defects of said object based on said image.
